(19) United States
(12) Patent Application Publication
(10) Pub. No.: US 2010/0318237 A1
(43) Pub. Date: Dec. 16, 2010

(54) SYSTEM AND METHOD FOR ENERGY DEVICE MANAGEMENT

(76) Inventor: Chad L. Maglaque, Seattle, WA (US)

Correspondence Address: K&L GATES LLP, 210 SIXTH AVENUE, PITTSBURGH, PA, 15222-2613, US

(21) Appl. No.: 12/814,295

(22) Filed: Jun. 11, 2010

Related U.S. Application Data
(60) Provisional application No. 61/186,008, filed on Jun. 11, 2009.

(51) Int. Cl. G06F 1/26

(52) U.S. Cl. 700/295

(57) ABSTRACT

A system for managing energy device operation is disclosed. The system includes one or more network-enabled energy devices and an energy management system comprising at least one processor. The energy management system is to establish a network connection with each energy device via a first communication network, and to query each energy device to cause the energy management system to receive first information from each energy device via the first network. The first information includes, for each energy device, a first operating mode of the energy device. The first operating mode is a current operating mode of the energy device. The energy management system is to determine, for each energy device, a second operating mode based on at least one operational rule stored in a first database. For each energy device, when the second operating mode is different than the first operating mode, energy management system is to transmit an instruction to the energy device to change the first operating mode of the device to the second operating mode.

### CROSS REFERENCE TO RELATED APPLICATIONS

This application claims priority to U.S. Provisional Patent Application Ser. No. 61/186,008 filed Jun. 11, 2009, the disclosure of which is attached at Appendix A hereto and incorporated herein by reference.

### BACKGROUND

Renewable energy sources, such as wind and solar energy, are inherently unpredictable to an extent. When sufficient power can be generated from such resources, it may be necessary for power utilities to reduce energy production from other energy sources (e.g., coal, gas) in order to maintain a balanced energy output. Maintaining a ready availability of additional energy reserves to meet demand when the output from renewable energy sources fluctuates is also required. Such requirements may increase capital outlays and underutilized capacity.

Distributed energy resources, such as residential and commercial solar and wind-powered systems, are currently operated as autonomous points within a local utility grid. Such resources are important, but their use in managing balanced energy output and energy capacity is often overlooked.

### SUMMARY

A system for managing energy device operation is disclosed. In one embodiment, the system includes one or more network-enabled energy devices and an energy management system comprising at least one processor. The energy management system is to establish a network connection with each energy device via a first communication network, and to query each energy device to cause the energy management system to receive first information from each energy device via the first network. The first information includes, for each energy device, a first operating mode of the energy device. The first operating mode is a current operating mode of the energy device. The energy management system is to determine, for each energy device, a second operating mode based on at least one operational rule stored in a first database. For each energy device, when the second operating mode is different than the first operating mode, energy management system is to transmit an instruction to the energy device to change the first operating mode of the device to the second operating mode.

### DESCRIPTION OF THE FIGURES

Various embodiments of the present application are described herein by way of example in conjunction with the following figures, wherein:

FIG. 1 illustrates a system for managing operation of one or more energy devices according to one embodiment;

FIG. 2 illustrates communication between an energy device and an energy management system according to one embodiment;

FIGS. 3A-3C illustrate information listings returned or transmitted by energy devices according to various embodiments;

FIG. 4 illustrates a premises area network according to one embodiment;

FIG. 5 illustrates an energy device management workflow according to one embodiment;

FIG. 6 is a tabulation of operating modes for different energy device types according to one embodiment; and

FIG. 7 illustrates a computing device according to one embodiment.

### DESCRIPTION

Described herein are various embodiments of a system and method that benefits consumers, energy service providers and others by matching inherently unpredictable sources of energy, such as wind energy and solar energy, with energy load sources to improve comfort and convenience when these sources of energy become available and to improve the regulation of energy production in real-time, and in turn, increase energy service efficiency and reliability.

The term “consumer” as used herein refers to either a person or entity that consumes resources, including without limitation electricity, natural gas, water, or other resources. The term “energy service provider” as used herein refers to an entity which provides energy services to consumers, including without limitation electric and gas utilities, retail electric and gas providers, energy management service providers and energy service aggregators. The term “energy service” as used herein includes without limitation commercial energy services, energy management services and energy aggregation services.

The term “energy device” as used herein includes without limitation an energy generating device, an energy consuming device or a hybrid energy generating-consuming device such as a battery storage device or other energy storage device. The term “energy generating device” as used herein includes without limitation any device (e.g., a fluid-driven turbine, a solar panel, a hydro-electric generator, a battery storage device, a flywheel, a fuel cell, a gas reformer) suitable for converting kinetic or potential energy (e.g., chemical energy, gravitational energy, mechanical energy, nuclear energy, thermal energy, light energy, EMF, kinematic energy, sound energy) into energy (e.g., electrical energy or chemical energy) that may be used, for example, in commercial or residential applications. The term “energy consuming device” as used herein includes without limitation any device (e.g., a motor, a light bulb, a heater, a radio, a battery charger) that converts energy (e.g., electrical energy or chemical energy) available from, for example, commercial or residential energy sources, into kinetic or potential energy. The term “commercial energy service” as used herein refers to a source of energy for a premises, including without limitation electrical or natural gas distribution networks managed by public utility companies or other entities. The term “premises” as used herein includes without limitation any permanent or temporary, stationary or mobile, structure used or intended for supporting or sheltering any use or occupancy. Examples of premises include without limitation residential homes, commercial buildings, temporary shelters, vehicles, watercraft, airplanes and spacecraft. The term “premises area network” (PAN) as used herein refers to an energy-related network used for communicating with devices within a premises. A PAN may be connected to one or more communication networks external to a premises, but does not necessarily require connectivity outside the premises.

U.S. patent application Ser. No. 12/712,166 filed Feb. 24, 2010, entitled ELECTRICAL POWER GENERATION APPARATUS, discloses embodiments of an energy device and is incorporated herein by reference in its entirety.

U.S. patent application Ser. No. 12/783,407 filed May 19, 2010, entitled SYSTEM AND METHOD FOR ENERGY DEVICE ACTIVATION, discloses a system and method for activating an energy device and is incorporated herein by reference in its entirety.

### Energy Management System Configuration

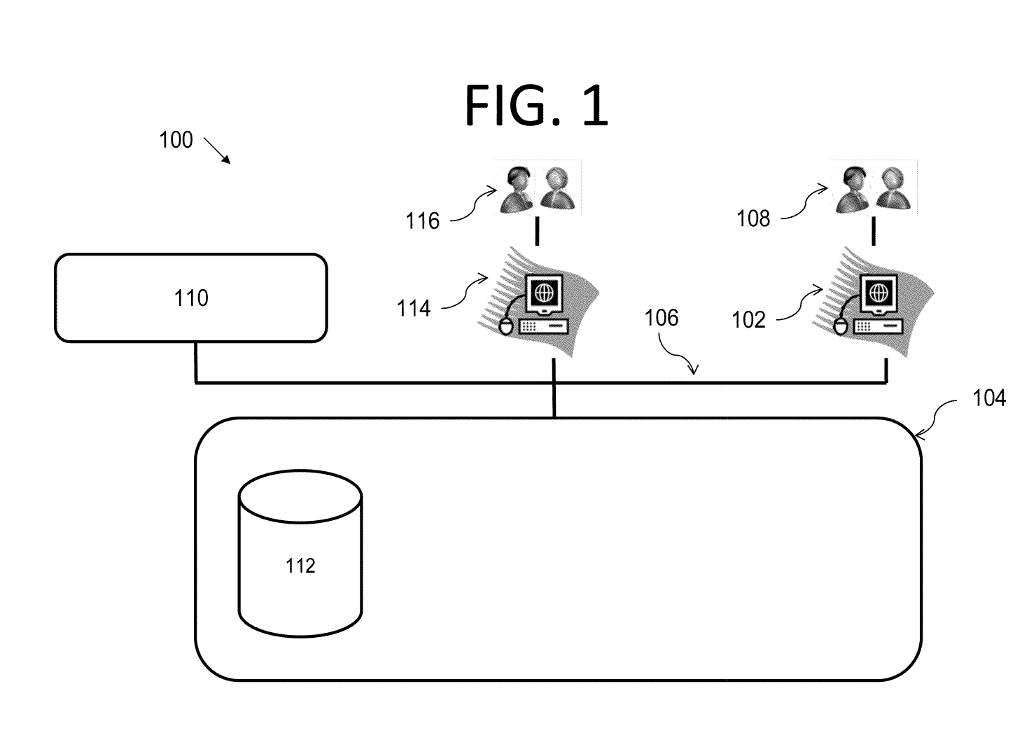

FIG. 1 illustrates one embodiment of a system 100 for matching energy sources that are inherently unpredictable (e.g., renewable energy sources such as wind energy and solar energy), with energy load sources. An energy service provider interface 102 (e.g., a processor-based device, such as a computer, for example) is connected to an energy management system 104 via a communication network 106 to enable an energy service provider 108 to enter, update, edit and/or remove operational rules for managing operation of one or more classes of energy devices 110 (e.g., a fluid-driven turbine, a solar panel, a hydro-electric generator, a battery storage device, a flywheel, a fuel cell, a gas reformer, a motor, a light bulb, a heater, a radio, a battery charger), and to enable storage and retrieval of this information in and from an approved operational rules database 112. The energy management system 104 may be connected to the energy devices 110 via a communication network, such as, for example, the communication network 106. The operational rules may specify, among other things, conditions under which the one or more classes of energy devices 110 are to be activated or deactivated.

Operational rules may specify, for example, that activation or deactivation of an energy device(s) 110 is to be responsive to one or more of: energy service provider directive(s) or instruction(s), market price condition(s), and information specific to an energy device 110 (e.g., whether the device supports energy generation and/or consumption modes, a maximum power consumption and/or maximum power output of the device, a maximum energy storage capacity of the device, a current operational mode of the device (e.g., generate, consume, idle) and operational parameters such as, for example, voltage(s), current(s), duty cycle, an amount of energy currently stored by the device, a depth of discharge value, temperature(s), barometric pressure(s), humidity, dew point, wind direction and wind speed).

The term “communication network” as used herein includes without limitation one or more of the Internet, a local area network (LAN) and a wide area network (WAN). Communication over the communication network may be effected using, for example, wired technologies such as Ethernet, twisted pair, coaxial cable, optical fiber and energy line communication (PLC) and/or wireless technologies such as Wi-Fi/IEEE 802.11x, Bluetooth, Zigbee, WiMAX, General Packet Radio Service (GPRS), EDGE, CDMA, GSM, microwave, and infrared. Additionally, information may be transmitted as a single stream or multiplexed to combine multiple analog message signals or digital data streams into a single signal.

In certain embodiments, one or more energy management systems 104 may be connected to an external energy management service via a communication network, such as the communication network 106 in FIG. 1. In yet further embodiments, one or more energy management systems 104 may be connected to one or more energy devices 110 via a communication network, such as the communication network 106 in FIG. 1. The term “energy management system” as used herein refers to a processor-based programmed to communicate with and manage one or more energy-controllable devices (e.g., programmed to interface with a PAN to manage one or more energy-controllable PAN devices, such as a programmable thermostat, a light switch, a solar panel module, a fluid-driven turbine, a plug-in electric vehicle). In certain embodiments, the energy management system may reside within a PAN device (e.g., a programmable thermostat, an in-home display, a computer, a cable set-top box, other computing device), provide auditing/logging functions that record transactions to and from PAN devices, and coordinate the exchange of credentials and operational privileges to activate and connect PAN devices with an energy service program. The energy management system may also communicate with and manage other devices or systems inside or outside the premises to provide integrated automated services for the consumer, and may be controlled by a third party or energy management service.

In certain embodiments, a consumer interface 114 comprising a processor-based device, such as a computer, for example, may be connected to the energy management system 104 via a communication network, such as the communication network 106, for example, to enable a consumer 116 to enter, update, edit and/or remove operational rules for managing the operation of one or more classes of energy devices 110 connected to the energy management system 104.

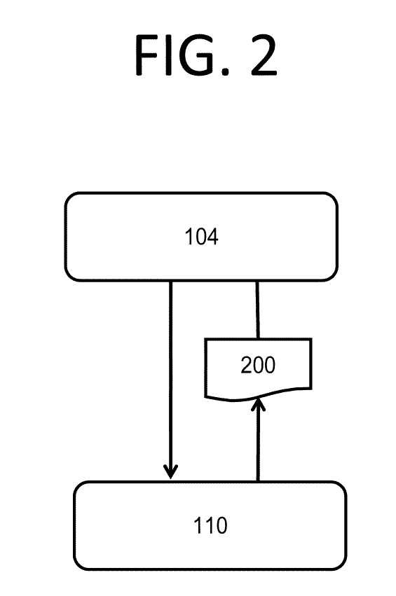

FIG. 2 illustrates communication between an energy device 110 and the energy management system 104 according to one embodiment. In one embodiment, the energy device 110 may be queried by the energy management system 104, for example, in response to satisfaction of a condition(s) contained in an operational rule(s). As discussed above, the operational rule(s) may dictate activation or deactivation of an energy device(s) 110 based on for example, any one of: energy service provider directive(s) or instruction(s), market price condition(s), and information specific to an energy device 110 (e.g., whether the device supports energy generation and/or consumption modes, a maximum power consumption and/or maximum power output of the device, a maximum energy storage capacity of the device, a current operational mode of the device (e.g., generate, consume, idle) and operational parameters such as, for example, voltage(s), current(s), duty cycle, an amount of energy currently stored by the device, a depth of discharge value, temperature(s), barometric pressure(s), humidity, dew point, wind direction and wind speed). An energy device 110 may respond to a query by returning a listing 200 of information specific to the energy device 110. The information listing 200 may include without limitation a unique energy device identifier (e.g., a serial number, a MAC ID), a hardware build of the device, a hardware version of the device, a hardware date of the device, a firmware version of the device, a firmware date of the device, a firmware build of the device, whether the device supports energy generation and/or consumption modes, a maximum power consumption and/or maximum power output of the device, a maximum energy storage capacity of the device, a current operational mode of the device (e.g., generate, consume, idle) and operational parameters such as, for example, voltage(s), current(s), duty cycle, an amount of energy currently stored by the device, a depth of discharge value, temperature(s), barometric pressure(s), humidity, dew point, wind direction and wind speed. In certain embodiments, the energy device 110 may transmit the information listing 200 to the energy management system 104 at recurring times, periodic (e.g. every second) or otherwise.

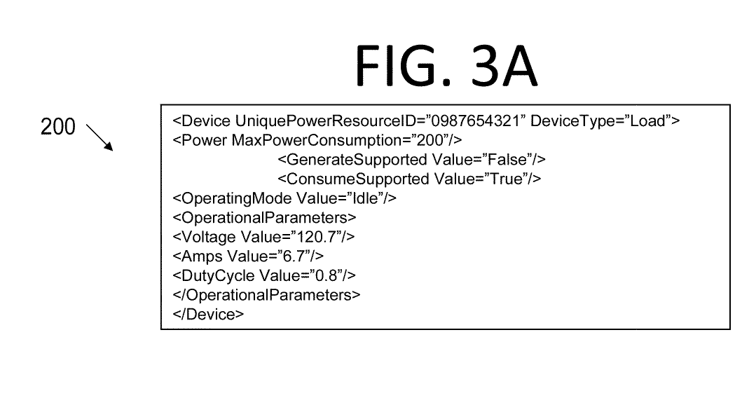

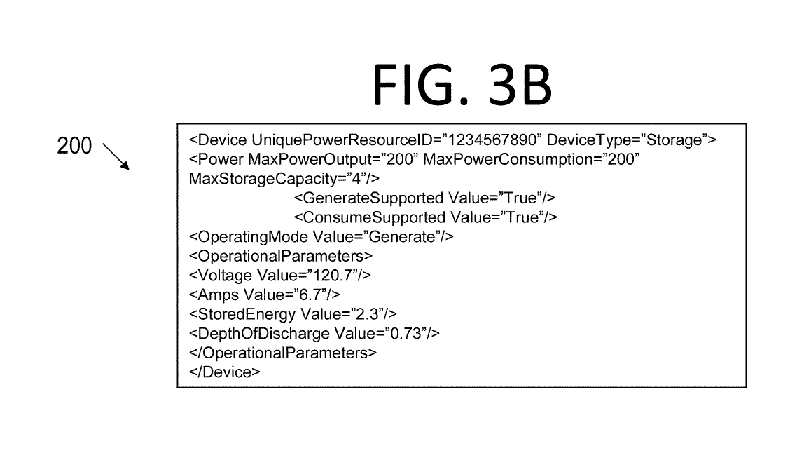

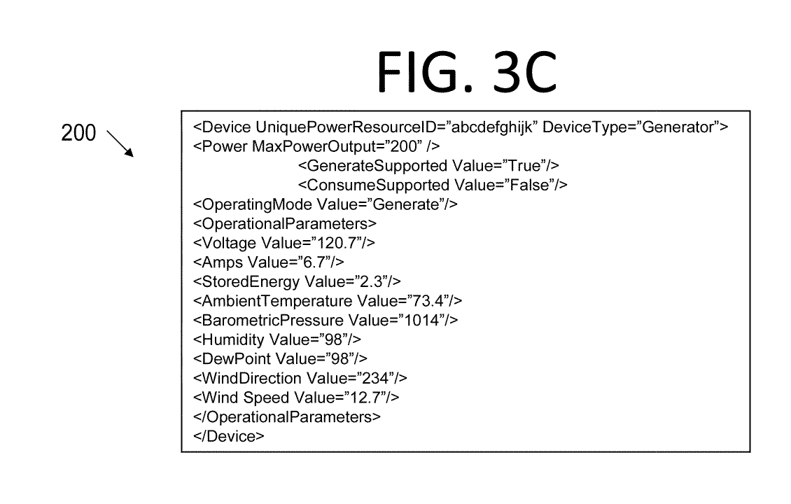

FIGS. 3A-3C illustrate examples of information listings 200 that may be returned or otherwise transmitted by an energy device 110 according to various embodiments. In certain embodiments and as shown in FIGS. 3A-3C, the listings 200 may be in an XML format. In FIG. 3A, the listing 200 is returned by an energy consuming device, in FIG. 3B, the listing 200 is returned by an energy storage device, and in FIG. 3C, the listing 200 is returned by an energy generating device.

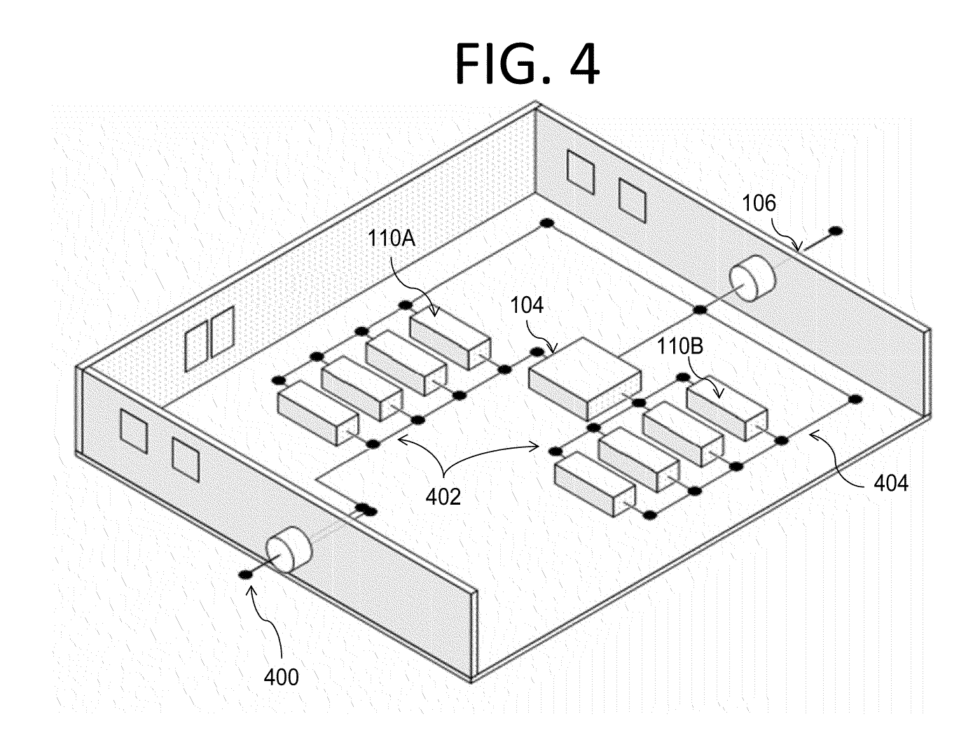

FIG. 4 illustrates a premises area network according to one embodiment. The energy management system 104, energy consuming devices 110A and energy generating devices 110B may be connected to a commercial energy service 400 via a power bus 402. The energy management system 104, energy consuming devices 110A and energy generating devices 110B may communicate via a premises area network 404 and may also be connected to an external energy service (not shown) via a communication network, such as, for example, the communication network 106.

### Operation

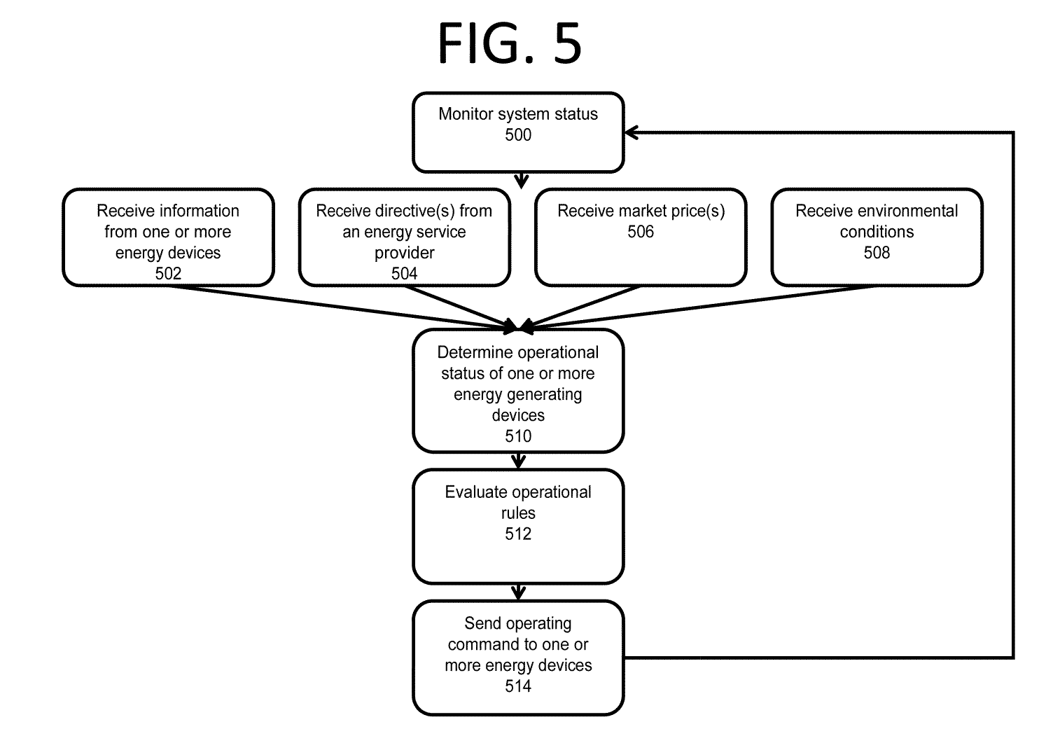

FIG. 5 illustrates an energy device management workflow according to one embodiment. With reference to FIG. 4, the energy management system 104 may connected to one or more energy consuming and generating devices 110A, 110B via a premises area network 404.

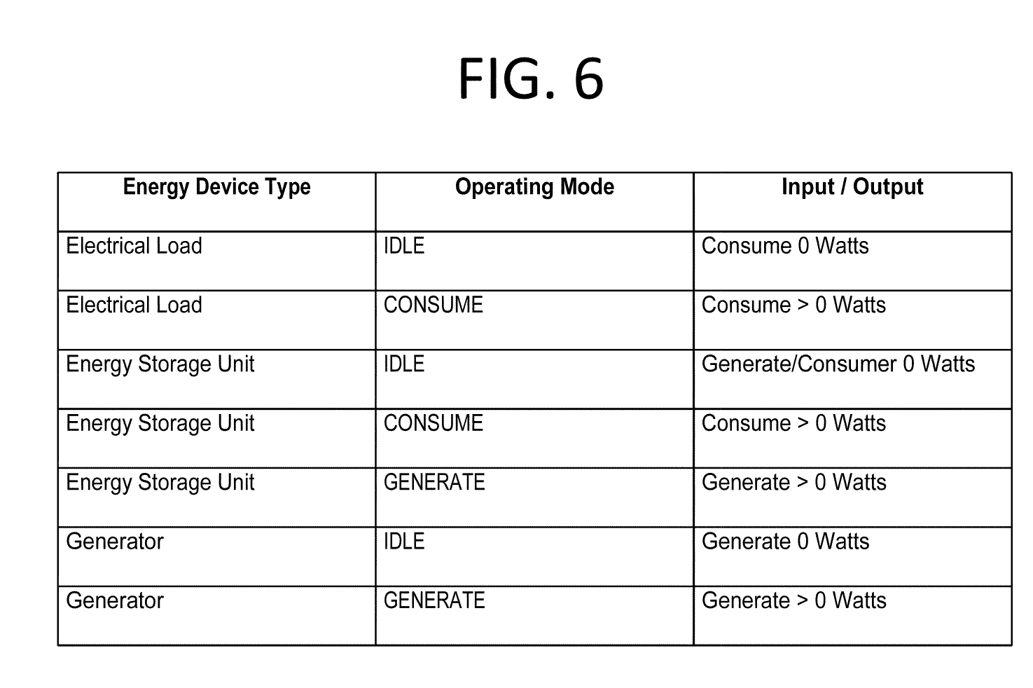

The energy management system 104 monitors 500 system status to receive 502 (e.g., periodically or otherwise) information from the energy consuming and generating devices 110A, 110E connected to the premises area network 404 (e.g., as described above in connection with FIGS. 3A-3C). The energy management system 104 receives 504 directive(s) or instruction(s) from an energy service provider 108, receives 506 market price(s), and/or receives 508 environmental conditions (e.g., indoor and/or outdoor temperature(s), barometric pressure(s), humidity, dew point, wind direction, wind speed, forecast weather condition(s)). If an information listing 200 from an energy generating device 110B connected to the premises area network 404 has not been received, the energy management system 104 may query or otherwise receive 510 from the device 110B updated information. In certain embodiments, in response to one or more of these events 502-510, one or more of the energy consuming and generating devices 110A, 110B may switched to a different operating mode, that is, from or to generate mode, consume mode or idle mode according to the operational rules stored in the operational rules database 112 for a given set of directive(s), market condition(s), environmental conditions and listing 200 information. A tabulation of operating modes for different energy device types according to one embodiment is set forth in FIG. 6. If the energy management system 104 determines 512, by evaluating the operational rules, that one or more of the energy consuming and generating devices 110A, 110B should be switched to a different operating mode, the energy management system 104 issues 514 an instruction or command to those devices 110A, 110B for which the operating mode is to be changed.

In known demand response systems, energy consuming devices operating in consume mode (e.g., an air conditioner) may be set to idle mode in response to a directive from an energy service provider, or in response to an increase in the market price of electricity, independent of the operating mode of one or more energy generating devices, such as a solar energy system. Moreover, in such systems, energy generated by energy generating devices flows in an undirected fashion to wherever it is needed, including back to the energy service.

By contrast, in embodiments of the present application, the system 100 takes into account an operating status of one or more energy generating devices 110B, such as a solar energy system, as a part of its operational rules. For example, the energy management system 104 may issue an instruction to set an energy consuming device 110A (e.g., a heat pump) to consume mode (for example, to provide cooling or heating) when one or more energy generating devices 110B switch to (and for as long as the one or more energy generating devices 110B remain in) generate mode. This may be the case even though the market price of electricity may have risen, or a directive was issued by an energy service provider 108 to set one or more energy consuming devices 110A to idle mode. Alternatively, the energy management system 104 may issue an instruction to set an energy consuming device 110A to idle mode if the energy production of one or more energy generating devices 110B decreases by a certain amount. In another example, an energy consuming device 110A (e.g., a heat pump) currently in idle mode may be set to consume mode by the energy management system 104 when one or more energy generating devices 110B switch to generate mode, for example, to pre-cool or pre-heat a thermal mass in advance of an forecasted change in ambient temperature. Alternatively, energy management system 104 may issue an instruction to set an energy consuming device 110A back to idle mode if the energy production of one or more energy generating devices 110B falls by a certain amount. In yet another example, an energy generating device 110B, such as a solar energy system, currently in generating mode may be set to idle mode in response to either a directive from an energy service provider 108 or in response to a drop in the market price of electricity. For example, when secondary markets for energy regulation services exist in order to maintain stable grid voltage and frequency, it may be economically advantageous to forgo energy generation, even when the marginal cost of energy generation is at or near zero, as may be the case with certain solar energy systems. Alternatively, an energy generating device 110B, such as a solar energy system, currently set to idle mode may be set to generate mode in response to either a directive from an energy service provider 108 or in response to a rise in the market price of electricity. In a further example, when one or more energy generating devices 110B are currently in generate mode, an energy consuming device 110A, such as a heat pump, currently in idle mode may be set to consume mode by the energy management system 104, for example to pre-cool or pre-heat a thermal mass, in response to either a directive from an energy service provider or in response to a drop in the market price of electricity. Alternatively, when one or more energy generating devices 110B are currently in generate mode, an energy consuming device 110A, such as a heat pump, currently set to consume mode may be set to idle mode in response to either a directive from an energy service provider 108 or in response to a rise in the market price of electricity.

In each of the above examples, switching the operating mode of energy devices 110A, 110B may be determined either in response to a change in the operating mode of one or more other energy generating devices 110B, and/or in response to changes in device specific information, market prices, environmental conditions or energy service provider directives while one or more energy generating devices 110B are in generate mode.

It will be appreciated that although embodiments using operational rules based on energy service provider directive(s) or instruction(s), market price condition(s), and information specific to an energy device 110 are described, operational rules based on other types of conditions, events or forecasts are possible.

Although embodiments based on electrical generation and consumption are described, it will further be appreciated that embodiments relating to the generation and consumption of other resources (e.g., natural gas, water) are also possible.

### General

In certain embodiments, whenever an energy device 110 is triggered (e.g., when the energy device 110 is powered on), the energy device 110 may provide the energy management system 104 with its capabilities (e.g., device model, device class, energy rating, energy capacity, hardware build, hardware version, hardware date, firmware version, firmware date, firmware build). In certain embodiments, such information may be contained in a device certificate that is factory programmed in the energy device 110. The device certificate may persist for the lifetime of the energy device 110 or until the energy device 110 is re-programmed. In some embodiments, an energy device 110 may authenticate with the energy management system 104 or energy management service using the device certificate, and the energy management system 104 may subsequently grant an operational certificate to the energy device 110 based on its capabilities as presented in the device certificate and which may have an expiration date and contain certain operational privileges to generate and/or consume energy.

In certain embodiments, enablement of an energy device 110 may include, or granting or revoking an operational certificate; operational certificate may be stored in a non-volatile memory of energy device 110 and undergo evaluation by energy device 110 during its operation. The term “certificate” as used herein refers to an electronic document generated by a certificate authority which uses a digital signature to bind together a public key with an identity—information such as the name of a person or an organization, their address, and so forth. The certificate can be used to verify that a public key belongs to an individual or an organization. The term “certificate authority” as used herein refers to a trusted entity responsible for issuing digital certificates used to verify the digital identity of another entity such as a device. In one embodiment, a certificate authority digitally signs a certificate to provide traceability, or chaining, back to itself, or to a root authority.

It will be further appreciated that in some embodiments, the above-described process for operating an energy device 110 may take place directly between an energy device 110 and an energy service without the need for an energy management system 104 to serve as an intermediary between the two. Furthermore, although embodiments involving an energy management system 104 located within a premise are described herein, alternative embodiments involving one or more energy management systems 104 external to a premises and operated by an energy management service which aggregates energy being_consumed or generated by a plurality of energy devices 110 located in a plurality of premises across a communication network, such as the communication network 106, are possible.

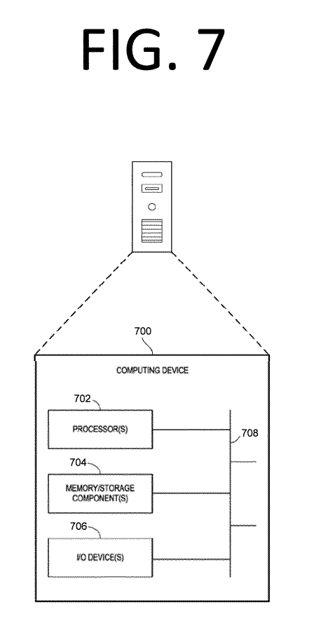

It will be appreciated by one of ordinary skill in the art that at least some of the embodiments described herein or parts thereof may be implemented using hardware, firmware and/or software. The firmware and software may be implemented using any suitable computing device(s). FIG. 7 shows an example of a computing device 700 according to one embodiment that may be used for implementing, for example, the energy service provider interface 102, the consumer interface 114, the energy management system 104 and energy devices 110. For the sake of clarity, the computing device 700 is illustrated and described here in the context of a single computing device. However, it is to be appreciated and understood that any number of suitably configured computing devices 700 can be used to implement any of the described embodiments. It also will be appreciated that one such device or multiple devices may be shared in a time division multiplex mode among compensators for multiple power amplifiers, as may be the case, for example, in a base station of a mobile communication network. For example, in at least some implementations, multiple communicatively linked computing devices 700 are used. One or more of these devices may be communicatively linked in any suitable way such as via one or more networks. One or more networks can include, without limitation: the Internet, one or more local area networks (LANs), one or more wide area networks (WANs) or any combination thereof.

In this example, the computing device 700 may comprise one or more processor circuits or processing units 702, one or more memory circuits and/or storage circuit component(s) 704 and one or more input/output (I/O) circuit devices 706. Additionally, the computing device 700 comprises a bus 708 that allows the various circuit components and devices to communicate with one another. The bus 708 represents one or more of any of several types of bus structures, including a memory bus or memory controller, a peripheral bus, an accelerated graphics port, and a processor or local bus using any of a variety of bus architectures. The bus 708 may comprise wired and/or wireless buses.

The processing unit 702 may be responsible for executing various software programs such as system programs, applications programs, and/or program modules/blocks to provide computing and processing operations for the computing device 700. The processing unit 702 may be responsible for performing various voice and data communication operations for the computing device 700 such as transmitting and receiving voice and data information over one or more wired or wireless communication channels. Although the processing unit 702 of the computing device 700 is shown in the context of a single processor architecture, it may be appreciated that the computing device 700 may use any suitable processor architecture and/or any suitable number of processors in accordance with the described embodiments. In one embodiment, the processing unit 702 may be implemented using a single integrated processor.

The processing unit 702 may be implemented as a host central processing unit (CPU) using any suitable processor circuit or logic device (circuit), such as a as a general purpose processor. The processing unit 702 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 702 may be coupled to the memory and/or storage component(s) 704 through the bus 708. The bus 708 may comprise any suitable interface and/or bus architecture for allowing the processing unit 702 to access the memory and/or storage component(s) 704. Although the memory and/or storage component(s) 704 may be shown as being separate from the processing unit 702 for purposes of illustration, it is worthy to note that in various embodiments some portion or the entire memory and/or storage component(s) 704 may be included on the same integrated circuit as the processing unit 702. Alternatively, some portion or the entire memory and/or storage component(s) 704 may be disposed on an integrated circuit or other medium (e.g., hard disk drive) external to the integrated circuit of the processing unit 702. In various embodiments, the computing device 700 may comprise an expansion slot to support a multimedia and/or memory card, for example.

The memory and/or storage component(s) 704 represent one or more computer-readable media. The memory and/or storage component(s) 704 may be implemented using any computer-readable media capable of storing data such as volatile or non-volatile memory, removable or non-removable memory, erasable or non-erasable memory, writeable or re-writeable memory, and so forth. The memory and/or storage component(s) 704 may comprise volatile media (e.g., random access memory (RAM)) and/or nonvolatile media (e.g., read only memory (ROM), Flash memory, optical disks, magnetic disks and the like). The memory and/or storage component(s) 704 may comprise fixed media (e.g., RAM, ROM, a fixed hard drive) as well as removable media (e.g., a Flash memory drive, a removable hard drive, an optical disk). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 706 may allow a user to enter commands and information to the computing device 700, and also may allow information to be presented to the user and/or other components or devices. Examples of input devices include data ports, ADCs, DACs, a keyboard, a cursor control device (e.g., a mouse), a microphone, a scanner and the like. Examples of output devices include data ports, ADCs, DACs, a display device (e.g., a monitor or projector, speakers, a printer, a network card). The computing device 700 may comprise an alphanumeric keypad coupled to the processing unit 702. The keypad may comprise, for example, a QWERTY key layout and an integrated number dial pad. The computing device 700 may comprise a display coupled to the processing unit 702. The display may comprise any suitable visual interface for displaying content to a user of the computing device 700. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 702 may be arranged to provide processing or computing resources to the computing device 700. For example, the processing unit 702 may be responsible for executing various software programs including system programs such as operating system (OS) and application programs. System programs generally may assist in the running of the computing device 700 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, Java OS, or other suitable OS in accordance with the described embodiments. The computing device 700 may comprise other system programs such as device drivers, programming tools, utility programs, software libraries, application programming interfaces (APIs), and so forth.

Various embodiments may be described herein in the general context of computer executable instructions, such as software or program modules/blocks, being executed by a computer. Generally, program modules/blocks include any software element arranged to perform particular operations or implement particular abstract data types. Software can include routines, programs, objects, components, data structures and the like that perform particular tasks or implement particular abstract data types. An implementation of these modules/blocks or components and techniques may be stored on some form of computer-readable media. In this regard, computer-readable media can be any available medium or media used to store information and accessible by a computing device. Some embodiments also may be practiced in distributed computing environments where operations are performed by one or more remote processing devices that are linked through a communication network. In a distributed computing environment, program modules/blocks may be located in both local and remote computer storage media including memory storage devices.

Although some embodiments may be illustrated and described as comprising functional component or modules/blocks performing various operations, it can be appreciated that such components or modules/blocks may be implemented by one or more hardware components, software components, and/or combination thereof The functional components and/or modules/blocks may be implemented, for example, by logic (e.g., instructions, data, and/or code) to be executed by a logic device (e.g., processor). Such logic may be stored internally or externally to a logic device on one or more types of computer-readable storage media. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSPs), field programmable gate array (FPGA), logic gates, registers, semiconductor devices, chips, microchips, chip sets, and so forth. Examples of software may include software components, programs, applications, computer programs, application programs, system programs, machine programs, operating system software, middleware, firmware, software modules/blocks, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

It also is to be appreciated that the described embodiments illustrate example implementations, and that the functional components and/or modules/blocks may be implemented in various other ways which are consistent with the described embodiments. Furthermore, the operations performed by such components and/or modules/blocks may be combined and/or separated for a given implementation and may be performed by a greater number or fewer number of components and modules/blocks.

It will be further appreciated that retrieval and storage of information in embodiments described herein may be implemented using hardware, firmware and/or software that employ four well-known basic functions of persistent storage: create, read, update and delete, with data transmitted to one or more memory circuits and/or storage circuit component(s) and between computing devices via one or more communications networks.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the embodiments.

What is claimed is:

1. A system to manage energy device operation, the system comprising:
one or more network-enabled energy devices; and
an energy management system comprising at least one processor, wherein the energy management system is to:
establish a network connection with each one of the one or more energy devices via a first communication network;
query the one or more energy devices to cause the energy management system to receive first information from the one or more energy devices via the first network, the first information comprising, for each one of the one or more energy devices, a first operating mode of the energy device, wherein the first operating mode is a current operating mode of the energy device;
for each one of the one or more energy devices, determine a second operating mode based on at least one operational rule stored in a first database;
for each one of the one or more energy devices, when the second operating mode is different than the first operating mode, transmit an instruction to the energy device to change the first operating mode of the device to the second operating mode.

2. The system of claim 1, wherein the one or more energy devices and the energy management system are located within a premises.

3. The system of claim 1, wherein the first information comprises, for each one of the one or more energy devices, at least one of:
one or more operational modes supported by the energy device;
a maximum power consumption of the energy device;
a maximum power output of the energy device;
a maximum energy storage capacity of the energy device;
an output voltage of the energy device;
an output current of the energy device;
a duty cycle of the energy device;
an amount of energy stored by the energy device;
a depth of discharge value;
a temperature;
a barometric pressure;
a humidity;
a dew point;
a wind direction; and
a wind speed.

4. The system of claim 3, wherein the one or more operational modes comprise one or more of a generate mode, a consume mode and an idle mode.

5. The system of claim 1, wherein the energy management system is to receive second information via a second network, the second information comprising at least one of:
one or more directives from an energy service provider;
one or more energy market prices; and
environmental condition information.

6. The system of claim 5, wherein the first network comprises a premises area network, and wherein the second network comprises the Internet.

7. The system of claim 5, wherein the energy management system is to determine the second operating mode based on an application of the at least one operational rule to the first and second information.

8. The system of claim 1, comprising a service provider interface in communication with the energy management system via a second communication network, the service provider interface comprising at least one processor, wherein the service provider interface is to:
enter, edit or delete information stored in the first database.

9. The system of claim 1, comprising a consumer interface in communication with the energy management system via a second communication network, the consumer interface comprising at least one processor, wherein the consumer interface is to:
enter, edit or delete information stored in the first database.

10. The system of claim 1, wherein the at least one operational rule comprises a plurality of operational rules, the plurality of operational rules comprising at least one of:
an operational rule specifying an operating mode of an energy device based on an operating mode of at least one other energy device; and
an operational rule specifying an operating mode of an energy device based on one or more of the first information of the energy device and second information, wherein the second information comprises at least one of a directive from an energy service provider, an energy market price, and an environmental condition.

11. A method for managing energy device operation, the method comprising:
establishing, by an energy management system comprising at least one processor, a network connection between the energy management system and one or more energy devices via a first communication network;
querying, by the energy management system, the one or more energy devices to cause the energy management system to receive first information from the one or more energy devices via the first network, the first information comprising, for each one of the one or more energy devices, a first operating mode of the energy device, wherein the first operating mode is a current operating mode of the energy device;
for each one of the one or more energy devices, determining, by the energy management system, a second operating mode based on at least one operational rule stored in a first database;
for each one of the one or more energy devices, when the second operating mode is different than the first operating mode, transmitting, by the energy management system, an instruction to the energy device to change the first operating mode of the device to the second operating mode.

12. The method of claim 11, wherein querying the one or more energy devices to cause the energy management system to receive first information comprises receiving at least one of:
one or more operational modes supported by the energy device;
a maximum power consumption of the energy device;
a maximum power output of the energy device;
a maximum energy storage capacity of the energy device;
an output voltage of the energy device;
an output current of the energy device;
a duty cycle of the energy device;
an amount of energy stored by the energy device;
a depth of discharge value;
a temperature;
a barometric pressure;
a humidity;
a dew point;
a wind direction; and
a wind speed.

13. The method of claim 12, wherein the one or more operational modes comprise one or more of a generate mode, a consume mode and an idle mode.

14. The method of claim 11, comprising receiving second information via a second network, the second information comprising at least one of:
one or more directives from an energy service provider;
one or more energy market prices; and
environmental condition information.

15. The method of claim 14, comprising, for each one of the one or more energy devices, determining, by the energy management system, the second operating mode based on an application of the at least one operational rule to the first and second information.

16. The method of claim 11, wherein determining a second operating mode based on at least one operational rule comprises determining a second operating mode based on at least one of:
an operational rule specifying an operating mode of an energy device based on an operating mode of at least one other energy device; and
an operational rule specifying an operating mode of an energy device based on one or more of: the first information of the energy device, and second information comprising at least one of: a directive from an energy service provider, an energy market price, and an environmental condition.
